(19) United States
(12) Patent Application Publication
(10) Pub. No.: US 2018/0321539 A1
(43) Pub. Date: Nov. 8, 2018

(54) DISPLAY DEVICE

(71) Applicant: Japan Display Inc., Minato-ku (JP)

(72) Inventors: Gen KOIDE, Tokyo (JP); Hirotaka HAYASHI, Tokyo (JP)

(73) Assignee: Japan Display Inc., Minato-ku (JP)

(21) Appl. No.: 15/952,297

(22) Filed: Apr. 13, 2018

(30) Foreign Application Priority Data
May 2, 2017 (JP) 2017-091921

(51) Int. Cl. G02F 1/1345; G02F 1/1333; G02F 1/1362; G06F 3/041

(52) U.S. Cl. CPC G02F 1/13452; G02F 1/13458; G02F 1/1368; G02F 1/136286; G06F 3/0412; G02F 1/13338

(57) ABSTRACT

According to one embodiment, a display device includes a first substrate, a second substrate and a connecting material. The first substrate includes a first edge and a second edge in the first direction, a third edge in a second direction, a first round corner between the first edge and the third edge, a first electrode at the third edge, a pad electrode on a first edge side, and a connection line which electrically connects the first electrode and the pad electrode. The second substrate includes a basement having a through hole, and a second electrode around the through hole. The connecting material electrically connects the first electrode and the second electrode via the through hole. The connection line has a first portion which is rounded at the first round corner.

### CROSS-REFERENCE TO RELATED APPLICATIONS

This application is based upon and claims the benefit of priority from Japanese Patent Application No. 2017-091921, filed May 2, 2017, the entire contents of which are incorporated herein by reference.

### FIELD

Embodiments described herein relate generally to a display device.

### BACKGROUND

A display device such as a liquid crystal display device or an organic electroluminescent display device has a display area which includes an array of pixels and a surrounding area which surrounds the display area. Peripheral circuits which drive the pixels are provided in the surrounding area.

Recently, various techniques for narrowing the frame of a display device have been considered. To narrow the frame of the display device, the area of the surrounding area needs to be reduced by arranging the peripheral circuits efficiently.

### BRIEF DESCRIPTION OF THE DRAWINGS

FIG. 1 is a plan view showing an example of the structure of a display device according to the present embodiment.

FIG. 2 is a plan view showing an example of the structure of a first substrate.

FIG. 3 is a plan view showing an example of the structure of a second substrate.

FIG. 4 is a plan view of the display device composed of the first substrate shown in FIG. 2 and the second substrate shown in FIG. 3.

FIG. 5 is a plan view showing an example of the structures of peripheral circuits near a round corner.

FIG. 6 is a plan view showing an example of the structure of a first electrode shown in FIG. 2.

FIG. 7 is a plan view showing an example of the structure of a detection electrode and a second electrode shown in FIG. 3.

FIG. 8 is a sectional view taken along line A-B shown in FIGS. 6 and 7.

FIG. 9 is a sectional view showing the structure of a display area of a display panel shown in FIG. 4.

FIG. 10 is an enlarged view of the vicinity of the round corner shown in FIG. 5.

FIG. 11 is an enlarged view of the vicinity of a round corner shown in FIG. 2.

FIG. 12 is an enlarged view of a connection line shown in FIG. 2.

### DETAILED DESCRIPTION

In general, according to one embodiment, a display device including a first substrate, a second substrate and a connecting material is provided. The first substrate includes a first edge and a second edge in the first direction, a third edge in a second direction intersecting the first direction, a first round corner between the first edge and the third edge, a first electrode at the third edge, a pad electrode on a first edge side, and a connection line which electrically connects the first electrode and the pad electrode.

The second substrate includes a basement having a through hole, and a second electrode around the through hole. The connecting material electrically connects the first electrode and the second electrode via the through hole. The connection line has a first portion which is rounded at the first round corner.

One embodiment will be described hereinafter with reference to the accompanying drawings. The disclosure is merely an example, and proper changes in keeping with the spirit of the invention, which are easily conceivable by a person of ordinary skill in the art, come within the scope of the invention as a matter of course. In addition, in some cases, in order to make the description clearer, the widths, thicknesses, shapes, etc., of the respective parts are illustrated schematically in the drawings, rather than as an accurate representation of what is implemented. However, such schematic illustration is merely exemplary, and in no way restricts the interpretation of the invention. In addition, in the specification and drawings, structural elements which function in the same or a similar manner to those described in connection with preceding drawings are denoted by like reference numbers, detailed description thereof being omitted unless necessary.

In the present embodiment, a liquid crystal display device having a touch detection function will be illustrated as an example of the display device. For example, this liquid crystal display device can be used in various devices such as smartphones, tablet computes, mobile phones, notebook computers, in-car devices and game consoles. The main structure disclosed in the present embodiment can be applied to self-luminous display devices such as organic electroluminescent display devices, electronic paper-type display devices including electrophoretic elements, etc., display devices adopting micro-electromechanical systems (MEMS), display devices adopting electrochromism, etc.

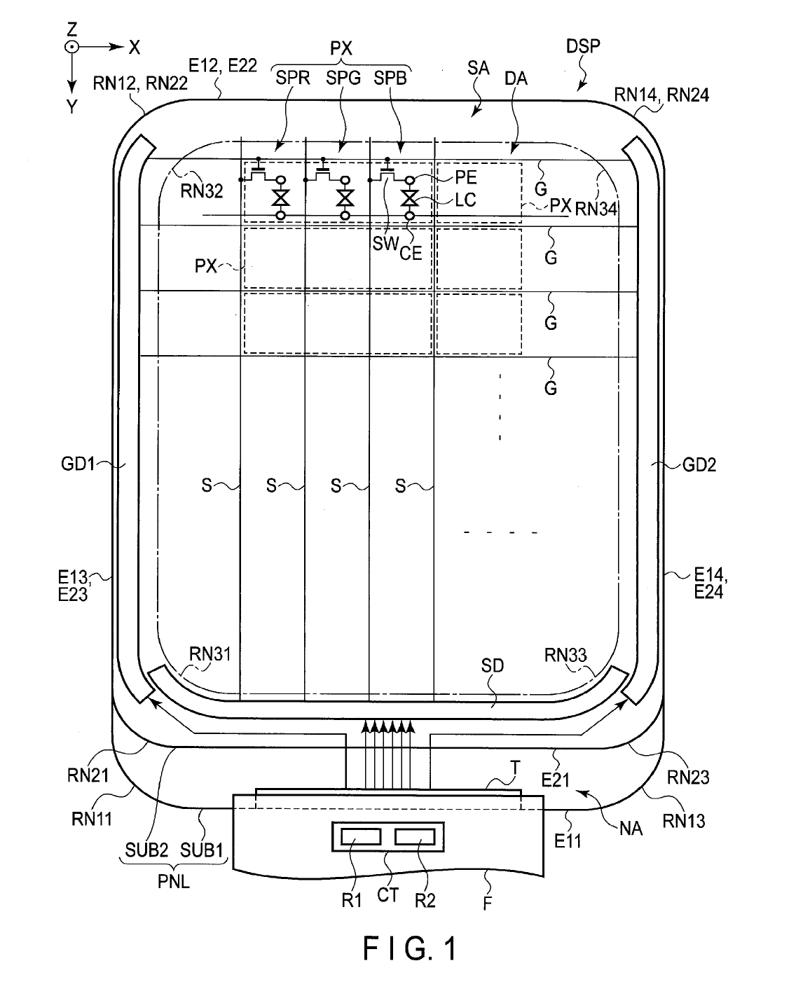

FIG. 1 is a plan view showing an example of the structure of a display device DSP according to the present embodiment.

In the drawing, a first direction X and a second direction Y are directions intersecting each other, and a third direction Z is a direction intersecting the first direction X and the second direction Y. The first direction X, the second direction Y and the third direction Z perpendicularly intersect each other, for example, but may intersect each other at an angle other than an angle of 90 degrees. In the present specification, a direction of the pointing end of an arrow indicating the third direction Z is referred to as upward (or simply above), and a direction opposite to the pointing end of the arrow is referred to as downward (or simply below).

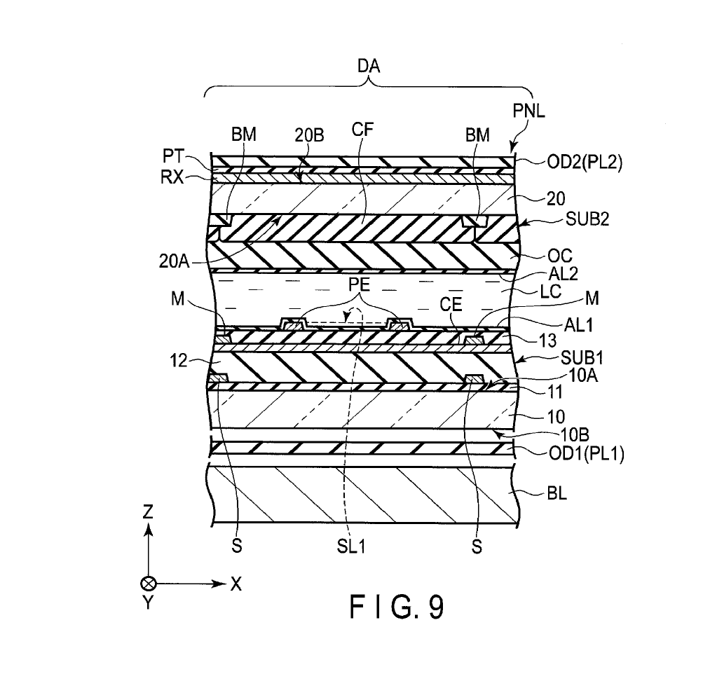

The display device DSP includes a display panel PNL, a wiring substrate F and a controller CT. The display panel PNL includes a first substrate SUB1, a second substrate SUB2, and a liquid crystal layer LC arranged between the first substrate SUB1 and the second substrate SUB2 (see FIG. 9 for details). The first substrate SUB1 and the second substrate SUB2 are attached to each other by a sealing material which is not shown in the drawing. Further, the display panel PNL includes a display area DA in which an image is displayed, and a frame-like surrounding area SA which surrounds the display area DA. The sealing material is arranged in the surrounding area SA.

The first substrate SUB1 has edges E11, E12, E13 and E14. Further, the second substrate SUB2 has edges E21, E22, E23 and E24. The edges E12 and E22 overlap each other, the edges E13 and E23 overlap each other, and the edges E14 and E24 overlap each other. The edge E21 is located on the edge E11 side and is located on the display area DA side from the edge E11. The display panel PNL has an unopposed area NA (or a terminal area) in which the first substrate SUB1 is not opposed to the second substrate SUB2 between the edges E11 and E21.

Further, the first substrate SUB1 has round corners RN11, RN12, RN13 and RN14. The second substrates SUB2 has round corners RN21, RN22, RN23 and RN24. The round corners RN12 and RN22 overlap each other, and the round corners RN14 and RN24 overlap each other. The round corner RN21 is located between the edge E21 and the edge E23 and is located on the display area DA side from the round corner RN11. The round corner RN23 is located on the display area DA side from the round corner RN13. The round corners RN21 and RN23 may be in the form of a square corner instead.

The display area DA has a round corner RN31 on the inner periphery side of the round corner RN21, a round corner RN32 on the inner peripheral side of the round corner RN22, a round corner RN33 on the inner peripheral side of the round corner RN23 and a round corner RN34 on the inner peripheral side of the round corner RN24. A dashed-dotted line in the drawing corresponds to the edges of the display area DA and the edges include the round corners RN31 to RN34.

The display panel PNL includes a plurality of scanning lines G and a plurality of signal lines S in the display area DA. The scanning lines G extend in the first direction X and are arranged at intervals in the second direction Y. The signal lines S extend in the second direction Y and are arranged at intervals in the first direction X.

The display area DA includes a plurality of pixels PX arranged in the first direction X and the second direction Y. The pixels PX correspond to areas enclosed with dotted lines in the drawing. Each pixel PX includes sub-pixels SP which display different colors. For example, the pixel PX include a sub-pixel SPR which displays red, a sub-pixel SPG which displays green, and a sub-pixel SPB which displays blue. The pixel PX does not necessarily have this structure, and may further include a sub-pixel which displays white, for example, or may include a plurality of sub-pixels corresponding to the same color. In the description, a sub-pixel may be referred to simply as a pixel in some cases.

Each sub-pixel SP includes a switching element SW, a pixel electrode PE and a common electrode CE. One common electrode CE is formed across a plurality of sub-pixels SP, for example. The switching element SW is electrically connected to the scanning line G, the signal line S and the pixel electrode PE.

The display panel PNL includes scanning line drivers GD1 and GD2 connected to the scanning lines G, and a signal line driver SD connected to the signal lines S. The scanning line driver GD1 is arranged between the display area DA and the edge E13, and the scanning line driver GD2 is arranged between the display area DA and the edge E14. The signal line driver SD is arranged between the display area DA and the edge E21. One of the scanning line drivers GD1 and GD2 may be omitted.

In the example shown in FIG. 1, the scanning line driver GD1 is provided in an area which is curved in an arc-like manner similarly to the round corners RN31 and RN32 near the round corners RN31 and RN32. The scanning line driver GD2 is provided in an area which is curved in an arc-like manner similarly to the round corners RN33 and RN34 near the round corners RN33 and RN34. The signal line driver SD is provided in an area which is curved in an arc-like manner similarly to the round corners RN31 and RN33 near the round corners RN31 and RN33. An end of the signal line driver SD near the round corner RN31 is located between the scanning line driver GD1 and the display area DA. An end of the signal line driver SD near the round corner RN33 is located between the scanning line driver GD2 and the display area DA.

The scanning line drivers GD1 and GD2 supply scanning signals to the scanning lines G. The signal line driver SD supplies video signals to the signal lines S. When a scanning signal is supplied to the scanning line G corresponding to a switching element SW and a video signal is supplied to the signal line S connected to the switching element SW, voltage corresponding to the video signal is applied to the pixel electrode PE. On the other hand, voltage corresponding to a direct-current common signal is applied to the common electrode CE. At this time, an alignment state of liquid crystal molecules included in the liquid crystal layer LC varies depending on the magnitude of an electric field generated between the pixel electrode PE and the common electrode CE. According to these operations, an image is displayed in the display area DA.

A connection terminal T is provided along the edge E11 in the unopposed area NA. The wiring substrate F is connected to the connection terminal T. The wiring substrate F is a flexible substrate, for example. As the flexible substrate applicable to the present embodiment, at least part of the substrate includes a flexible portion formed of a bendable material. For example, the wiring substrate F of the present embodiment may be a flexible substrate which is entirely formed as a flexible portion or may be a rigid flexible substrate which includes a rigid portion formed of a rigid material such as glass epoxy and a flexible portion formed of a bendable material such as polyimide.

In the example shown in FIG. 1, a controller CT is mounted on the wiring substrate F. The controller CT includes a display driver R1 which controls the scanning line drivers GD1 and GD2 and the signal line driver SD, and a detection driver R2 which is used for touch detection. The display driver R1 and the detection driver R2 are not necessarily mounted in this manner and may be mounted on the first substrate SUB1, for example. Alternatively, the display driver R1 and the detection driver R2 may be mounted on different members.

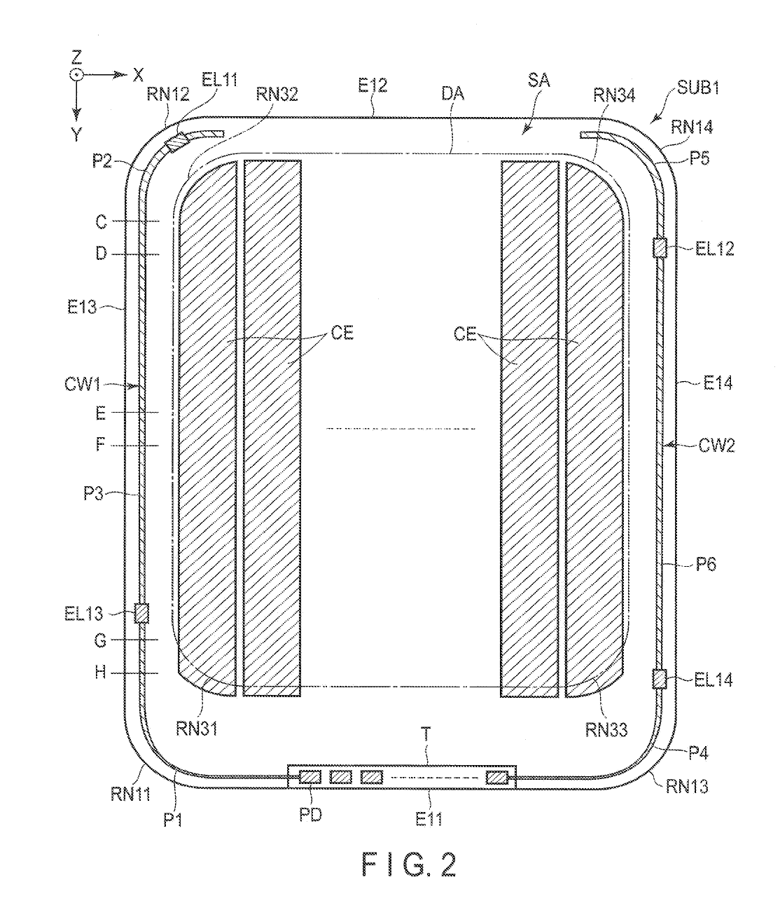

FIG. 2 is a plan view showing an example of the structure of the first substrate SUB1.

In the example illustrated, the first substrate SUB1 includes the common electrode CE, first electrodes EL11 to EL14, connection lines CW1 and CW2, and the connection terminal T. The connection terminal T includes a plurality of pad electrodes PD. Each of the connection lines CW1 and CW2 is composed of a plurality of wiring lines as will be described later, but illustration thereof is omitted in the drawing.

The edges E11 and E12 extend in the first direction X. The edge E12 is located on the opposite side of the display area DA from the edge E11. The edges E13 and E14 extend in the second direction Y. The edge E14 is located on the opposite side of the display area DA from the edge E13.

The round corner RN11 is located between the edge E11 and the edge E13. The round corner RN12 is located between the edge E12 and the edge E13. The round corner RN13 is located between the edge E11 and the edge E14. The round corner RN14 is located between the edge E12 and the edge E14.

The first electrodes EL11 to EL14, the pad electrodes PD and the connection lines CW1 and CW2 are arranged in the surrounding area SA. The pad electrodes PD are arranged along the edge E11. The connection lines CW1 and CW2 electrically connect the first electrodes EL11 to EL14 and the pad electrodes PD.

The connection line CW1 has a first portion P1 which is rounded along the round corner RN11, a second portion P2 which is rounded along the round corner RN12, and a third portion P3 which is formed along the edge E13. The first portion P1 is located between the round corners RN11 and R31. The second portion P2 is located between the round corners RN12 and RN32. The third portion P3 is located between the display area DA and the edge E13. The first electrode EL11 is arranged at a position overlapping the second portion P2. The first electrode EL13 is arranged at a position overlapping the third portion P3.

The connection line CW2 has a fourth portion P4 which is rounded along the round corner RN13, a fifth portion P5 which is rounded along the round corner RN14, and a sixth portion P6 which is formed along the edge E14. The fourth portion P4 is located between the round corners RN13 and R33. The fifth portion P5 is located between the round corners RN14 and RN34. The sixth portion P6 is located between the display area DA and the edge E14. The first electrodes EL12 and EL14 are arranged at positions overlapping the sixth portion P6.

When the second portion P2 and the fifth portion P5 are provided, the cell gap between the first substrate and the second substrate will be prevented from being narrowed near the round corners RN12 and RN14. Further, for example, the second portion P2 and the fifth portion P5 are formed in the same layer and formed of the same material as the signal lines S shown in FIG. 1.

The common electrodes CE are arranged in the display area DA. The common electrodes CE extend in the second direction Y and are arranged in the first direction X.

As will be described later, the first electrode EL11 may be arranged at a position overlapping the third portion P3 and may not be arranged at a position overlapping the second portion P2.

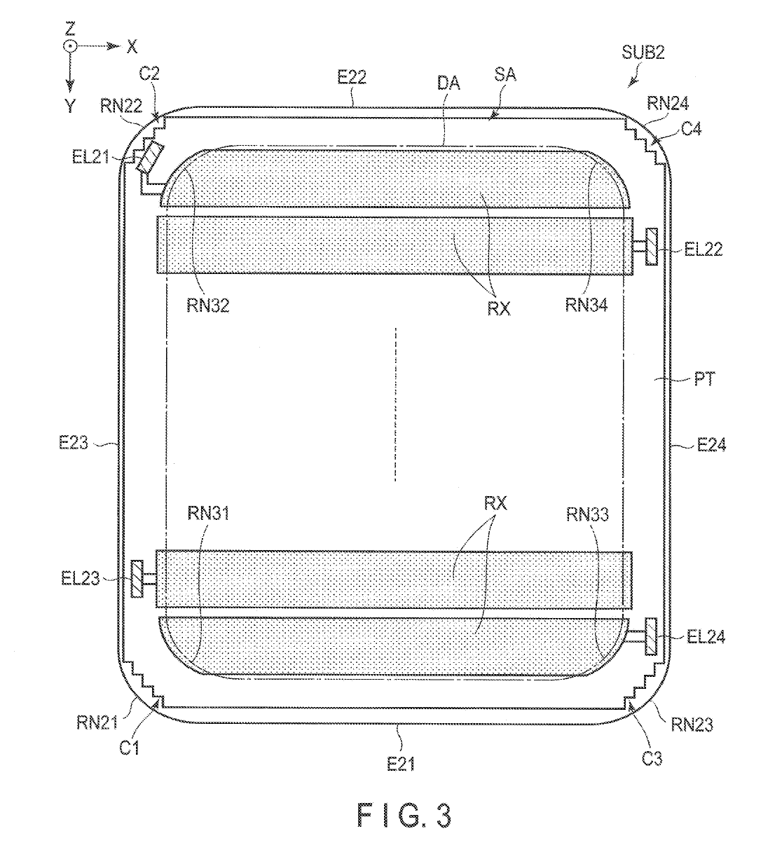

FIG. 3 is a plan view showing an example of the structure of the second substrate SUB2. In the example illustrated, the second substrate SUB2 includes detection electrodes RX, second electrodes EL21 to EL24, and a protective member PT.

The edges E21 and E22 extend in the first direction X. The edge E22 is located on the opposite side of the display area DA from the edge E21. The edges E23 and E24 extend in the second direction Y. The edge E24 is located on the opposite side of the display area DA from the edge E23.

The round corner RN21 is located between the edge E21 and the edge E23. The round corner RN22 is located between the edge E22 and the edge E23. The round corner RN23 is located between the edge E21 and the edge E24. The round corner RN24 is located between the edge E22 and the edge E24.

The protective material PT covers the detection electrodes RX. The protective material PT has a corner portion C1 located between the round corners RN21 and RN31, a corner portion C2 located between the round corners RN22 and RN32, a corner portion C3 located between the round corners RN23 and RN33, and a corner portion C4 located between the round corner RN24 and RN34. In the example illustrated, the corner portions C1 to C4 are formed of a dot pattern and have a sawtooth shape, but the corner portions C1 to C4 may be rounded similarly to the round corners RN21 to RN24. The protective member PT is not arranged at the edges E21 to E24 and the round corners RN21 to RN24. That is, the protective member PT is not arranged on the cut line of a cutter in the manufacturing process of cutting out the second substrate SUB2. Therefore, the cutter blade will be prevented from slipping on the protective member PT.

The detection electrodes RX extend in the first direction X and are arranged in the second direction Y in the display area DA.

The second electrodes EL21 to EL24 are arranged in the surrounding area SA. The second electrodes EL21 to EL24 are electrically connected to the detection electrodes RX, respectively. The second electrode EL21 is located between the round corners RN22 and RN32. The second electrodes EL22 and EL24 are located between the display area DA and the edge E24. The second electrode EL23 is located between the display area DA and the edge E23.

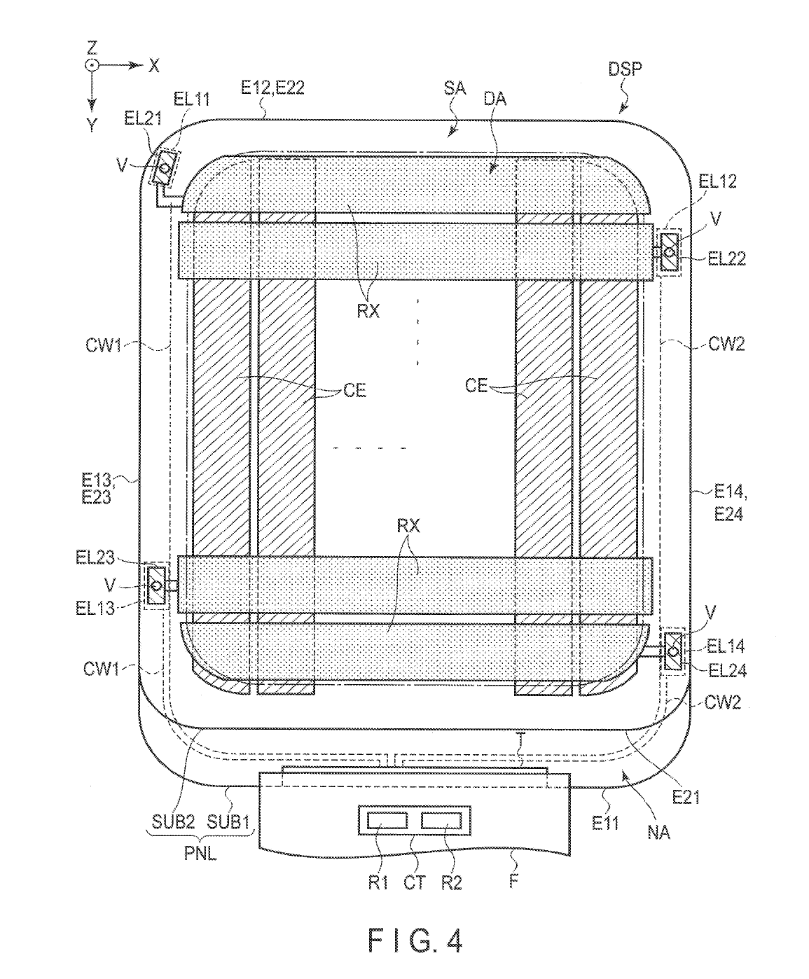

FIG. 4 is a plan view of the display device DSP composed of the first substrate SUB1 shown in FIG. 2 and the second substrate SUB2 shown in FIG. 3.

Each common electrode CE not only functions as an electrode for displaying an image but also functions as a drive electrode for detecting an object which approaches or contacts the display area DA together with each detection electrode RX.

The common electrodes CE (or drive electrodes) may be provided on the second substrate SUB2. Further, the display device DSP may also adopt a structure in which drive electrodes are further provided in addition to the detection electrodes RX and the common electrodes CE. More specifically, for example, drive electrodes other than the detection electrodes RX and the common electrodes CE may be provided on a transparent basement arranged on a display surface of the display panel PNL.

Further, the detection electrodes RX and the common electrodes CE (or drive electrodes) can be arranged in various other manners. For example, the detection electrodes RX may extend in the second direction Y and are arranged in the first direction X, and the common electrodes CE may extend in the first direction X and may be arranged in the first direction Y.

The first electrodes EL11 to EL14 overlap the second electrodes EL21 to EL24, respectively. The second electrodes EL21 to EL24 are electrically connected to the first electrodes EL11 to EL14 via contact holes V, respectively. For example, as illustrated in the drawing, the odd-numbered detection electrodes RX from the edge E22 are connected to the first electrodes arranged between the edge E23 and the display area DA, and the even-numbered detection electrodes RX from the edge E22 are connected to the first electrodes arranged between the edge E24 and the display area DA. The connection lines CW1 and CW2 extend to the outside of the area of the first substrate SUB1 which overlaps the second substrate SUB2, that is, to the unopposed area NA.

According to the above-described structure, the second electrodes EL21 to EL24 are electrically connected to the wiring substrate F via the first electrodes EL11 to EL14, the connection lines CW1 and CW2, etc. Therefore, a control circuit which writes signals to the detection electrodes RX or reads signals output from the detection electrodes RX can be connected to the detection electrodes RX via the wiring substrate F. It is no longer necessary to mount another wiring substrate on the second substrate SUB2 to connect the detection electrodes RX and the control circuit.

Further, according to the present embodiment, as compared to a case where a wiring substrate other than the wiring substrate F mounted on the first substrate SUB1 is mounted on the second substrate SUB2, a terminal for mounting the wiring substrate or routing lines for connecting the second electrodes and the wiring substrate will not be required. Therefore, in the X-Y plane defined by the first direction X and the second direction Y, the substrate size of the second substrate SUB2 can be reduced, and the frame width in the periphery of the display device DSP can be reduced. Further, the cost of the unnecessary wiring substrate will not be incurred. Therefore, the frame can be narrowed and the cost can be reduced.

Next, the structures of peripheral circuits (such as the scanning line drivers GD1 and GD2 and the signal line driver SD) arranged in the surrounding area SA will be described.

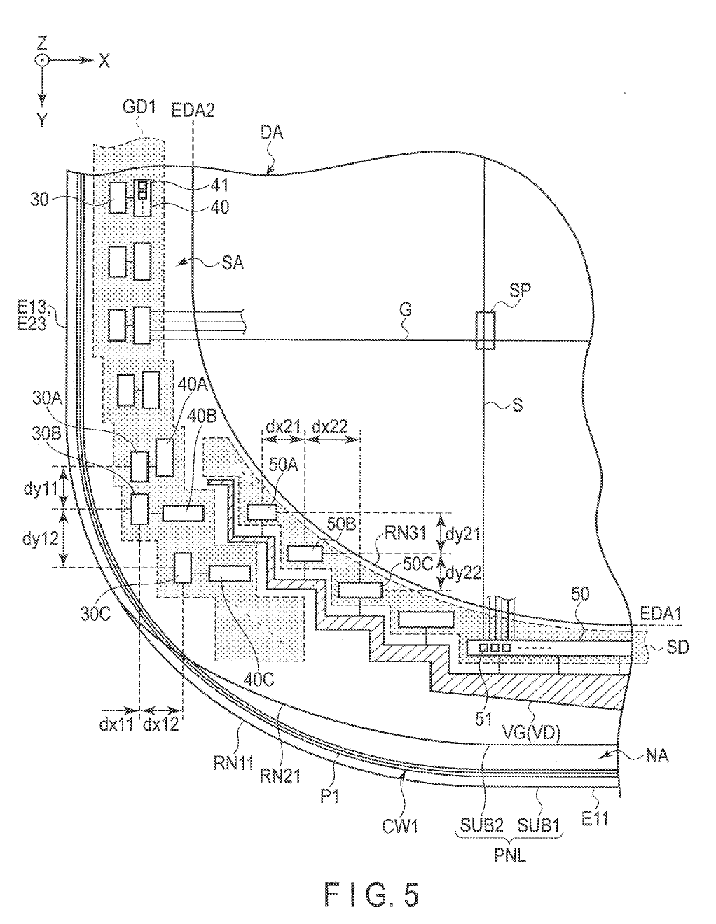

FIG. 5 is a plan view showing an example of the structures of peripheral circuits near the round corners RN11, RN21 and RN31.

The scanning line driver GD1 includes a plurality of shift register units 30 and a plurality of buffer units 40 each of which is connected to the corresponding shift register unit 30 and is connected to at least one scanning line G. Each shift register unit 30 constitutes a shift register which controls the timing of sequentially supplying a scanning signal to the scanning line G. Each buffer unit 40 includes at least one buffer circuit 41. The buffer circuit 41 supplies a scanning signal (scanning voltage) to the scanning line G under the control of the shift register unit 30.

The first substrate SUB1 includes a video line group VG including a plurality of video lines VD in the surrounding area SA. The video line group VG is arranged along the signal line driver SD. The video lines VD constituting the video line group VG are electrically connected to the display driver R1 via the connection terminal T and the wiring substrate F. In the example shown in FIG. 5, the signal line driver SD is arranged between the video line group VG and the display area DA. Further, in an area in which the signal line driver SD is located between the scanning line driver GD1 and the display area DA, the video line group VG is elongated between the scanning line driver GD1 and the signal line driver SD.

The signal line driver SD includes a plurality of selector units 50. Each selector unit 50 includes at least one selector circuit 51 (selector switch). The selector circuit 51 is connected to N video lines VD and M signal lines, where M is greater than N (M>N). For example, N is two and M is six (N=2 and M=6). The selector circuit 51 switches the signal lines S to be connected to the video lines VD in a time-sharing manner. Accordingly, video signals can be supplied to the signal lines S by the video lines VD which are fewer than the signal lines S arranged in the display area DA.

The connection lines CW1 which connect the detection electrodes RX and the terminal T are arranged along the edge of the first substrate SUB1. That is, the scanning line driver GD1, the signal line driver SD and the video group line VG are located between the connection lines CW1 and the display area DA. The distance between the connection lines CW1 and the edge of the first substrate SUB1 is entirely constant in the example shown in FIG. 5 but may vary from one portion to another. For example, the distance between the connection lines CW1 and the edge of the first substrate SUB1 may increase toward the edge E11 near the round corner RN11.

The scanning line driver GD1 and the signal line driver SD are provided in an area which is curved along the round corner RN31 near the round corner RN31 of the display area DA. Therefore, part of the signal line driver SD near the round corner RN31 is located on the edge E12 side (upper side in the drawing) from an edge EDA1 of the display area DA which is closest to the edge E11. Further, part of the scanning line driver GD1 near the round corner RN31 is located on the edge E14 side (right side in the drawing) from an edge EDA2 of the display area DA which is closest to the edge E13.

The number of the selector circuits 51 included in each selector unit 50 varies such that, as the selector unit 50 is closer to the end of the signal driver SD, the selector unit 50 includes fewer selector circuits 51. Accordingly, the width of each selector unit 50 in the first direction X varies such that, as the selector unit 50 is closer to the end of the signal line driver SD, the selector unit 50 is narrower in the first direction X.

In the example shown in FIG. 5, the video line group VG is arranged stepwise, and a portion extending in the first direction X and a portion extending in the second direction Y are alternately repeated, and one selector unit 50 is arranged with respect to one step. A plurality of selector units 50 may be arranged with respect to one step. Further, at least part of the video line group VG may extend in an oblique direction which intersects the first direction X and the second direction Y.

Here, for example, shift register units 30A, 30B and 30C and buffer units 40A, 40B and 40C connected thereto will be described among the shift register units 30 and the buffer units 40. The shift register unit 30A and the shift register unit 30B are adjacent to each other, and the shift register unit 30B and the shift register unit 30C are adjacent to each other. Further, the buffer unit 40A and the buffer unit 40B are adjacent to each other, and the buffer unit 40B and the buffer unit 40C are adjacent to each other.

The distance between the shift register unit 30A and the shift register unit 30B in the first direction X is defined as a distance dx11, the distance between the shift register unit 30B and the shift register unit 30C in the first direction X is defined as a distance dx12, the distance between the shift register unit 30A and the shift register unit 30B in the second direction Y is defined as a distance dy11, and the distance between the shift register unit 30B and the shift register unit 30C in the second direction Y is defined as distance dy12. In this case, the distance dx11 and the distance dx12 differ from each other in the example shown in FIG. 5. More specifically, the distance dx11 is less than the distance dx12 (dx11<dx12), and since the shift register units 30A and 30B are not misaligned with each other in the first direction X, the distance dx11 is zero. Further, the distance dy11 and the distance dy12 differ from each other in the example shown in FIG. 5. More specifically, the distance dy11 is less than the distance dy12 (dy11<dy12). As other examples, the shift register units 30A, 30B and 30C may be arranged in such a manner as to satisfy dx11>dx12 or may be arranged in such a manner as to satisfy dy11≥dy12.

In the example shown in FIG. 5, similarly to the distances dx11 and dx12, the distance between the buffer unit 40A and the buffer unit 40B in the first direction X and the distance between the buffer unit 40B and the buffer unit 40C in the first direction X differ from each other. Further, similarly to the distances dy11 and dy12, the distance between the buffer unit 40A and the buffer unit 40B in the second direction Y and the distance between the buffer unit 40B and the buffer unit 40C in the second direction Y differ from each other. The buffer units 40A, 40B and 40C are arranged stepwise such that distances thereof to the round corner RN 31 in the first direction X will be substantially equal to each other.

Further, for example, selector units 50A, 50B and 50C will be described among the selector units 50. The selector unit 50A and the selector unit 50B are adjacent to each other, and the selector unit 50B and the selector unit 50C are adjacent to each other. The selector units 50A, 50B and 50C are misaligned with each other in the first direction X and the second direction Y. The selector unit 50B is located on the side of the end of the signal line driver SD from the selector unit 50A, and the selector unit 50C is located on the side of the end of the signal line driver SD from the selector unit 50B. The width of the selector unit 50A in the first direction X is less than the width of the selector unit 50C.

The distance between the selector unit 50A and the selector unit 50B in the first direction X is defined as a distance dx21, the distance between the selector unit 50B and the selector unit 50C in the first direction X is defined as a distance dx22, the distance between the selector unit 50A and the selector unit 50B in the second direction Y is defined as a distance dy21, and the distance between the selector unit 50B and the selector unit 50C in the second direction Y is defined as a distance dy22. In this case, the distance dx21 and the distance dx22 differ from each other in the example shown in FIG. 5. More specifically, the distance dx21 is less than the distance dx22 (dx21<dx22). Further, the distance dy21 and the distance dy22 are substantially equal to each other in the example shown in FIG. 5. As other examples, the selector units 50A, 50B and 50C may be arranged in such a manner as to satisfy dx21≥dx22 or may be arranged such that the distance dy21 and the distance dy22 differ from each other. The buffer units 50A, 50B and 50C are arranged stepwise such that distances thereof to the round corner RN 31 in the second direction Y are substantially equal to each other.

In this way, it is possible to realize the scan line driver GD1 which is curved in an arc-like manner along the round corner RN31 by adjusting the distances between the shift register units 30 and the distances of the buffer units 40 in the directions X and Y near the round corner C31. Similarly, it is possible to realize the signal line driver SD which is curved in an arc-like manner along the round corner RN31 by adjusting the distances of the selector units 50 in the directions X and Y near the round corner RN31.

In the above description, the distance (dx11, dx12, dx21, dx22, etc.) between two adjacent units in the first direction X corresponds to the distance between the centers of the units in the first direction X. Further, the distance (dy11, dy12, dy21, dy22, etc.) between two adjacent units in the second direction Y corresponds to the distance between the centers of the units in the second direction Y.

The structure of the scanning line driver GD1 near the round corner RN32 of the display area DA shown in FIG. 1 is the same as the structure of the scanning line driver GD1 near the round corner RN31. Further, the structures of the scanning line driver GD2, the signal line driver SD, the video line group VG and the connection lines CW2 near the round corner RN33 of the display area DA are the same as structures thereof near the round corner RN 31. Still further, the structure of the scanning line driver GD2 near the round corner RN34 of the display area DA is the same as the structure of the scanning line driver GD1 near the round corner RN32. The structure of the surrounding area SA near the round corners RN31 to RN34 is not limited to that of the illustrated example and can be appropriately modified in consideration of the layouts of circuits and wiring lines to be arranged.

According to the present embodiment, the first substrate SUB1 has the round corner RN11, and the connection line CW1 has the first portion P1 which is rounded along the round corner RN11. Therefore, as compared to a case where the first portion P1 is linearly formed, a space between the first portion P1 and the round corner RN31 of the display area DA will be widened. Therefore, the space of the surrounding area SA can be efficiently used, and the frame can be narrowed. The same also applies to the other round corners RN12 to RN14 of the first substrate SUB1.

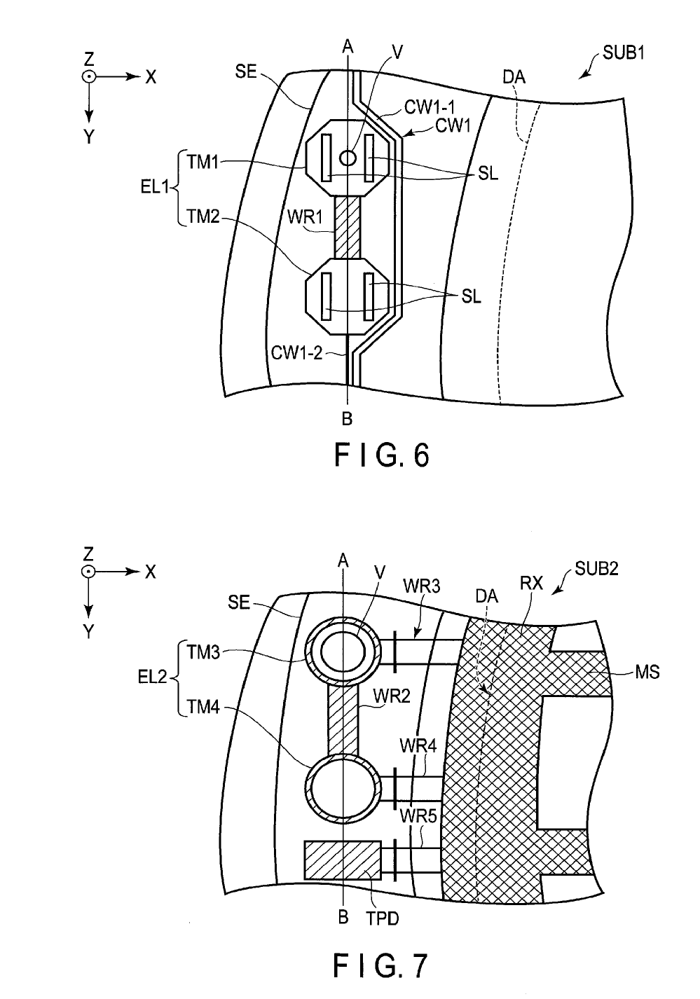

FIG. 6 is a plan view showing an example of the structure of the first electrode EL1 shown in FIG. 2.

The first electrode EL1 includes a first terminal TM1, a second terminal TM2 and a wiring line WR1. The first terminal TM1, the second terminal TM2 and the wiring line WR1 are arranged at positions overlapping the sealing material SE. The first terminal TM1 and the second terminal TM2 are arranged in the second direction Y and are electrically connected to each other by the wiring line WR1. Each of the first terminal TM1 and the second terminal TM2 has two slits SL. In the example illustrated, the slits SL extend in the second direction Y. The first terminal TM1 has the contact hole V between the two slits SL.

The connection lines CW1 extend in the second direction Y, and among the connection lines CW1, a connection line CW1-1 which is located above in the drawing and connects the first electrode EL1 and the second electrode EL2 is arranged toward the first terminal TM1 from above in the drawing, is redirected near the first terminal TM1 and arranged toward the display area DA along an inclined side of the octagon-shaped first terminal TM1, and is then redirected and arranged along a side of the first terminal MT1 extending in the second direction Y. Further, when the connection line CW1-1 approaches the second terminal TM2, the connection line CW1-1 is redirected and arranged away from the display area DA along a lower inclined side of the octagon-shaped second terminal TM2. That is, the connection lines CW1 are arranged in a shortest roundabout way while maintaining a distance from the first terminal TM1 and the second terminal TM2 such that the connection lines CW1 will not be short-circuited. Further, the octagon shape of the first terminal TM1 and the second terminal TM2 has an inclined side extending toward the display area DA, an inclined side extending away from the display area DA and a side extending in the extension direction of the connection lines CW1, that is, the second direction Y, and is suitable for forming the shortest roundabout way of the connection lines CW1.

A connection line CW1-2 is connected to a bottom side of the second terminal TM2 and extends in the second direction Y. When the connection line CW1-1 arranged from above in the drawing approaches the connection line CW1-2, the connection line CW1-1 is redirected to the second direction Y and arranged in the second direction Y along the connection line CW1-2.

FIG. 7 is a plan view showing an example of the structures of the detection electrodes RX and the second electrode EL2 shown in FIG. 3.

The second electrode EL2 includes a third terminal TM3, a fourth terminal TM4 and a wiring line WR2. The third terminal TM3, the fourth terminal TM4 and the wiring line WR2 are arranged at positions overlapping the sealing material SE. The third terminal TM3 and the fourth terminal TM4 are arranged in the second direction Y and are electrically connected to each other by the wiring line WR2. The third terminal TM3 and the fourth terminal TM4 have the shape of a circular ring. The third terminal TM3 is connected to the detection electrode RX via a wiring line WR3. The fourth terminal TM4 is connected to the detection electrode RX via a wiring line WR4. The detection electrode RX is formed of a metal wire mesh MS. The second substrate SUB2 has the contact hole V within the third terminal TM3.

The second substrate SUB2 further includes an inspection pad TPD which is arranged along with the second electrode EL2 in the second direction Y. The inspection pad TPD is electrically connected to the detection electrode RX via a wiring line WR5.

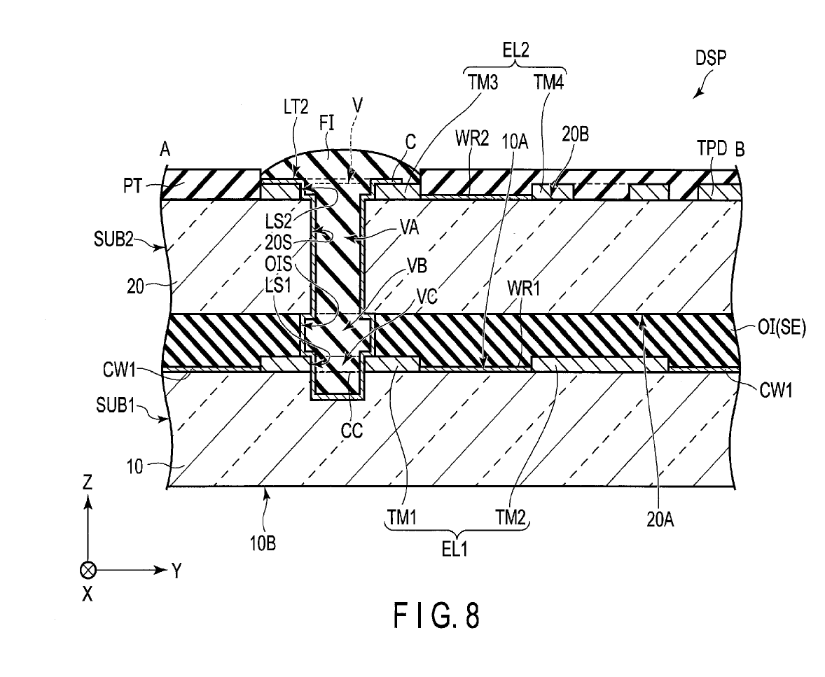

FIG. 8 is a sectional view taken along line A-B shown in FIGS. 6 and 7.

The display device DSP includes the first substrate SUB1, the second substrate SUB2, an organic insulating film OI, a connecting material C and a filling material FI. The first substrate SUB1 and the second substrate SUB2 are opposed to each other in the third direction Z.

The first substrate SUB1 includes a first basement 10, the first terminal TM1, the third terminal TM3, the wiring line WR1 and the connection line CW1. The first basement 10 has a surface 10A which is opposed to the second substrate SUB2 and a surface 10B which is opposite to the first surface 10A. In the example illustrated, the first terminal TM1, the third terminal TM3, the wiring line WR1 and the connection line CW1 are located on the surface 10A side. Although not shown in the drawing, various insulating films or various conductive films may be arranged between the first terminal TM1, the third terminal TM3, the wiring line WR1 and the connection line CW1 and the first basement 10 or may be arranged on the first terminal TM1, the third terminal TM3, the wiring line WR1 and the connection line CW1. Further, the first terminal TM1, the third terminal TM3, the wiring line WR1 and the connection line CW1 may be formed on different layers from each other via insulating films, etc.

The second substrate SUB2 includes a second basement 20, the second terminal TM2, the fourth terminal TM4, the inspection pad TPD, the protective member PT and the wiring line WR2. The second basement 20 has a surface 20A which is opposed to the first substrate SUB1 and a surface 20B which is opposite to the surface 20A. The surface 20A is opposed to the first terminal TM1 and is separated from the first terminal TM1 in the third direction Z. As the first basement 10 and the second basement 20, a glass substrate or a resin substrate can be adopted. In the example illustrated, the second terminal TM2, the fourth terminal TM4, the inspection pad PD, the protective member PT and the wiring line WR2 are located on the surface 20B side. The second terminal TM2 overlaps the first terminal TM1 in the third direction Z. The fourth terminal TM4 overlaps the third terminal TM3 in the third direction Z. The protective member PT covers the second terminal TM2, the fourth terminal TM4, the wiring line WR2 and the inspection pad PD. Further, although not shown in the drawing, various insulating films or various conductive films may be arranged between the second terminal TM2, the fourth terminal TM4, the wiring line WR2 and the inspection pad PD and the second basement 20.

The organic insulating film OI is located between the first basement 10 and the second basement 20. Here, the organic insulating film OI includes the sealing material SE, and a light-shielding layer, a color filter, an overcoat layer, an alignment film, etc., which will be described later.

A connection structure for connecting the first terminal TM1 and the second terminal TM2 in the present embodiment will be described in detail.

In the second substrate SUB2, the second basement 20 has a through hole VA which penetrates between the surface 20A and the surface 20B. The second terminal TM2 is formed in the shape of a circular ring around the through hole VA.

The organic insulating film OI has a through hole VB which is continuous with the through hole VA between the first substrate SUB1 and the second substrate SUB2.

On the other hand, in the first substrate SUB1, the first terminal TM1 has a through hole VC which is continuous with the through hole VB. Further, the first basement 10 has a recess CC which is opposed to the through hole VC in the third direction Z. The recess CC is formed from the surface 10A toward the surface 10B but does not penetrate down to the surface 10B in the example illustrated. For example, the depth of the recess CC in the third direction Z is about ⅕ to about ½ of the thickness of the first basement 10 in the third direction Z. The first basement 10 may have a through hole which penetrates between the surface 10A and the surface 10B in place of the recess CC. The through holes VA, VB and VC and the recess CC are arranged in line in the third direction Z and constitute the contact hole V.

In the example illustrated, the through hole VB is expanded in the second direction Y as compared to the through holes VA and VC. The through hole VB is expanded not only in the second direction Y but also in all directions in the X-Y plane as compared to the through holes VA and VC.

The connecting material C electrically connects the first electrode EL1 and the second electrode EL2 via the through holes VA and VB. More specifically, the connecting material C electrically connects the first terminal TM1 and the third terminal TM3. The connecting material C is provided on the inner surfaces of the through holes VA, VB, VC and the recess CC. In the example illustrated, the connecting material C is continuously provided in the through holes VA, VB and VC and the recess CC. The connecting material C should preferably contain a metal material such as silver and should be a mixture of fine particles having a particle diameter of the order of several nanometers to several tens of nanometers and a solvent.

In the example illustrated, the connecting material C contacts an upper surface LT2 of the second terminal TM2, an inner surface LS2 of the second terminal TM2 and an inner surface 20S of the second basement 20, respectively. These inner surfaces LS2 and 20S constitute the inner surface of the through hole VA. The connecting material C contacts an inner surface OIS of the organic insulating film OI between the first substrate SUB1 and the second substrate SUB2. The inner surface OIS constitutes the inner surface of the through hole VB. Further, the connecting material C contacts an inner surface LS1 of the first terminal TM1 and the recess CC, respectively. The inner surface LS1 constitutes the inner surface of the through hole VC.

The connecting material C is provided on the inner surfaces of the through holes VA, VB and VC and the recess CC in the example illustrated, but the through holes VA, VB and VC and the recess CC may be filled with the connecting material C instead. In that case, the connecting material C is also continuously formed between the first terminal TM1 and the second terminal TM2.

A hollow in the contact hole V is filled with the filling material FI. Further, the filling material FI is also arranged above the second terminal TM2 and covers the connecting material C and the second terminal TM2. The filling material FI is insulative, for example, and is formed of an organic insulating material. As described above, as the filling material FI is arranged, steps resulting from the hollow in the contact hole V in the third direction Z can be smoothed. Further, the connecting material C can be protected. Still further, the filling material FI may be conductive and may be a hardened paste containing conductive particles such as silver, for example. If the filling material FI is conductive, even when the connecting material C is disconnected, the first terminal TM1 and the second terminal TM2 can be electrically connected to each other by the filling material FI, and the reliability can be improved.

According to the structural example shown in FIG. 8, the display device DSP includes the third terminal TM3, the fourth terminal TM4 and the inspection pad TPD. Therefore, a continuity state between the first terminal TM1 and the second terminal TM2 is inspected in a state where the connecting material C is formed in the contact hole V, and if a continuity failure is found, another contact hole which connects the third terminal TM3 and the fourth terminal TM4 may be formed in some cases.

FIG. 9 is a sectional view showing the structure of the display area DA of the display panel PNL shown in FIG. 4.

The illustrated display panel PNL conforms to a display mode which mainly uses a lateral electric field which is substantially parallel to a substrate surface. The display panel PNL may conform to a display mode which uses a longitudinal electric field which is perpendicular to a substrate surface, a display mode which uses an oblique electric field which is inclined with respect to a substrate surface, or a display mode which uses a combination thereof. In the display mode using the lateral electric field, for example, the display panel PNL may have a structure in which both the pixel electrode PE and the common electrode CE are provided on one of the first substrate SUB1 and the second substrate SUB2, for example. In the display mode which uses the longitudinal electric field or the oblique field, the display panel PNL may have a structure in which one of the pixel electrode PE and the common electrode CE is provided on the first substrate SUB1 and the other one of the pixel electrode PE and the common electrode CE is provided on the second substrate SUB2. Note that the substrate surface here is a plane parallel to the X-Y plane.

The first substrate SUB1 includes the first basement 10, the signal line S, the common electrode CE, a metal layer M, the pixel electrode PE, a first insulating film 11, a second insulating film 12, a third insulating film 13, a first alignment film AL1, etc. Here, the switching element and the scanning line, and various insulating films interposed between them are not shown in the drawing.

The first insulating film 11 is located on the surface 10A of the first basement 10. The signal line S is located on the first insulating film 11. The second insulating film 12 is located on the signal line S and the first insulating film 11. The common electrode CE is located on the second insulating film 12. The metal layer M contacts the common electrode CE directly above the signal line S. The metal layer M is located on the common electrode CE in the example illustrated but may be located between the common electrode CE and the second insulating film 12. The third insulating film 13 is located on the common electrode CE and the metal layer M. The pixel electrode PE is located on the third insulating film 13. The pixel electrode PE is opposed to the common electrode CE via the third insulating film 13. Further, the pixel electrode PE has a slit SL1 at a position opposed to the common electrode CE. The first alignment film AL1 covers the pixel electrode PE and the third insulating film 13.

The first substrate SUB1 does not necessarily have the structure of the example illustrated, and the pixel electrode PE may be located between the second insulating film 12 and the third insulating film 13, and the common electrode CE may be located between the third insulating film 13 and the first alignment film AL1. In this case, the pixel electrodes PE has the shape of a flat plate having no slit, and the common electrode CE has a slit opposed to the pixel electrode PE. Further, both the pixel electrode PE and the common electrode CE may have the shape of a comb and may be engaged with each other.

The second substrate SUB2 includes the second basement 20, a light-shielding layer BM, a color filter CF, an overcoat layer OC, a second alignment film AL2, etc.

The light-shielding layer BM and the color filter CF are located on the surface 20A of the second basement 20. The light-shielding layer BM partitions the pixels and is located directly above the signal lines S. The color filters CF are opposed to the pixel electrodes PE and partially overlap the light-shielding layer BM. The color filters CF include a red color filter, a green color filter and a blue color filter. The overcoat layer OC covers the color filters CF. The second alignment film AL2 covers the overcoat layer OC.

Note that the color filters CF may be arranged on the first substrate SUB1. Further, the color filters CF may include color filters of four or more colors. A pixel which displays white may be provided with a white color filer or an uncolored resin material or may be provided with the overcoat layer OC without any color filter.

The detection electrode RX is located on the surface 20B. The detection electrode RX may be formed of a conductive layer containing metal or a transparent conductive material such as ITO or IZO, may have a multilayer structure in which a conductive layer containing metal is deposited on a transparent conductive layer, or may be formed of a conductive organic material, a dispersing element of a fine conductive substance, etc. The protective member PT covers the detection electrode RX.

A first optical element OD1 including the first polarizer PL1 is located between the first basement 10 and an illumination device BL. A second optical element OD2 including a second polarizer PL2 is located on the detection electrode RX. The first optical element OD1 and the second optical element OD2 may include retardation films, respectively, when needed.

The scanning line, the signal line S and the metal layer M may be formed of a metal material such as molybdenum, tungsten, titanium or aluminum, and may have a single layer structure or a multilayer structure. For example, the scanning line G is formed of a metal material containing molybdenum and tungsten, the signal line S is formed of a metal material containing aluminum and titanium, the metal layer M is formed of a metal material containing aluminum and molybdenum. The common electrode CE and the pixel electrode PE are formed of a transparent conductive material such as ITO or IZO. The first insulating film 11 and the third insulating film 13 are inorganic insulating films, and the second insulating film 12 is an organic insulating layer.

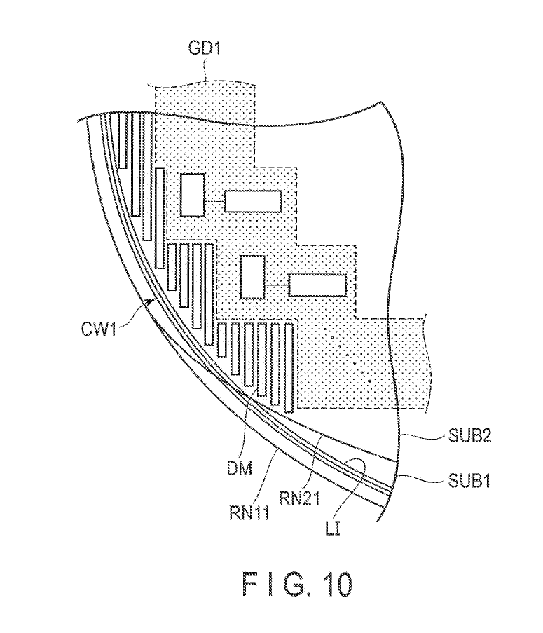

FIG. 10 is an enlarged view of the vicinity of the round corners RN11 and RN21 shown in FIG. 5. The first substrate SUB1 includes dummy electrodes DM.

The dummy electrodes DM are arranged between the connection lines CW1 and the scanning line driver GD1. The connection lines CW1 include an innermost line LI arranged on the scanning line driver GD1 side. The dummy electrodes DM are located between the innermost line LI and the scanning driver GD1 and do not overlap the connection lines CW1 and the scanning line driver GD1. The dummy electrodes DM are formed in the same layer and formed of the same material as the signal lines, for example.

This modification can also produce the same effect as that produced from the above-described embodiment.

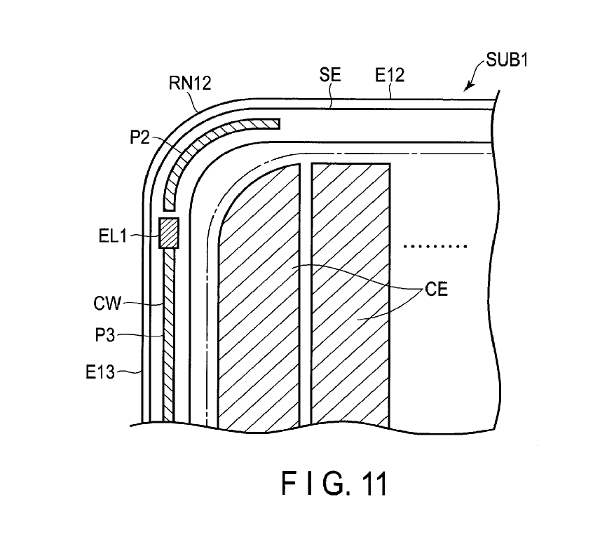

FIG. 11 is an enlarged view of the vicinity of the round corner RN12 shown in FIG. 2.

In the example illustrated, the second portion P2 is provided separately from the first electrode EL1. That is, the second portion P2 is electrically floating. The second portion P2 is arranged at a position overlapping the sealing material SE. The second portion P2 is formed of the same material as the third portion P3, for example. Further, the first electrode EL1 is arranged at a position overlapping the third portion P3. The second portion P2 may extend along the edge E12.

This modification can also produce the same effect as that produced from the above-described embodiment.

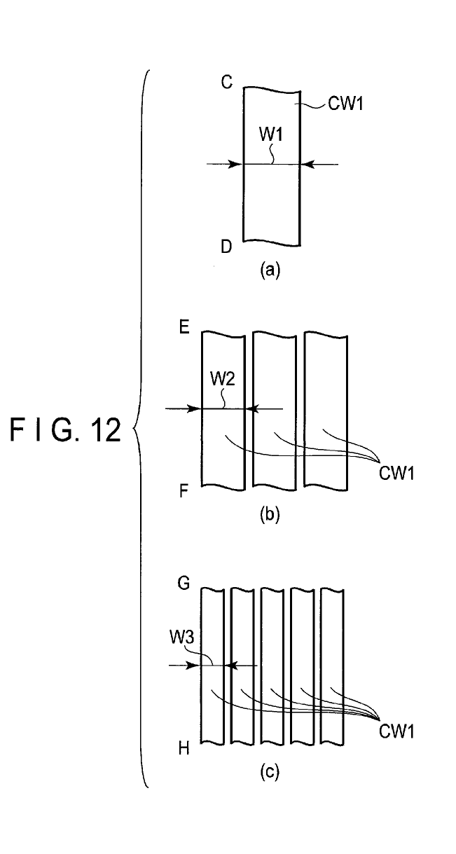

FIG. 12 is an enlarged view of the connection line CW1 shown in FIG. 2.

FIG. 12 (a) shows the connection line CW1 between a line C and a line D shown in FIG. 2. One connection line CW1 is formed between the line C and the line D. In FIG. 12 (a), the connection line CW1 has a width W1.

FIG. 12 (b) shows the connection lines CW1 between a line E and a line F shown in FIG. 2. Three connection lines CW1 are formed between the line E and the line F. In FIG. 12 (b), the connection lines CW1 have a width W2.

FIG. 12 (c) shows the connection lines CW1 between a line G and a line H shown in FIG. 2. Five connection lines CW1 are formed between the line G and the line H. In FIG. 12 (c), the connection lines CW1 have a width W3.

In the example illustrated, the width W2 is less than the width W1. Further, the width W3 is less than the width W2. That is, the connection line CW1 gradually becomes narrower from the edge E12 side to the edge E11 side. The connection line CW1 may gradually become narrower continuously or may gradually become narrower stepwise from the edge E12 side to the edge E11 side. As described above, the number of the connection lines CW1 increases from the edge E12 side to the edge E11 side, and therefore the arrangement area of the connection lines CW1 can be secured by narrowing the connection lines CW1 from the edge E12 side to the edge E11 side.

This modification can also produce the same effect as that produced from the above-described embodiment.

As described above, according to the present embodiment, a display device having a narrower frame can be obtained.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A display device comprising:
a first substrate including a first edge and a second edge which are elongated in the first direction, a third edge which is elongated in a second direction intersecting the first direction, a first round corner located between the first edge and the third edge, a first electrode arranged at the third edge, a pad electrode arranged on a first edge side, and a connection line which electrically connects the first electrode and the pad electrode;
a second substrate which is opposed to the first substrate, including a basement having a through hole, and a second electrode located around the through hole; and
a connecting material which electrically connects the first electrode and the second electrode via the through hole, wherein
the connection line has a first portion which is rounded at the first round corner.

2. The display device of claim 1, wherein
the first substrate includes a second round corner located between the second edge and the third edge, and
the connection line has a second portion which is rounded at the second round corner.

3. The display device of claim 2, wherein the first electrode is arranged at a position overlapping the second portion.

4. The display device of claim 2, wherein the second portion is separated from the first electrode and is electrically floating.

5. The display device of claim 1, wherein
the first electrode includes a first terminal and a second terminal which are arranged in the second direction, and the first terminal and the second terminal are electrically connected to each other,
the second electrode includes a third terminal overlapping the first terminal, and a fourth terminal overlapping the second terminal, and the third terminal and the fourth terminal are electrically connected to each other, and
the connecting material electrically connects the first terminal and the third terminal.

6. The display device of claim 5, further comprising a detection electrode which is connected to the third terminal and the fourth terminal.

7. The display device of claim 6, further comprising an inspection pad which is electrically connected to the detection electrode.

8. The display device of claim 6, further comprising a protective member which covers the detection electrode, wherein
the second substrate includes a fourth edge on the first edge side, a fifth edge overlapping the second edge, a sixth edge overlapping the third edge, a third round corner located between the fourth edge and the sixth edge, and a fourth round corner overlapping the second round corner, and
the protective member is not arranged at the fourth edge, the fifth edge, the sixth edge, the third round corner and the fourth round corner.

9. The display device of claim 1, wherein a width of the connection line on the first edge side is less than a width of the connection line on a second edge side.

10. The display device of claim 1, wherein
the first substrate includes a scanning line driver, and a dummy electrode arranged between the connection line and the scanning line driver.

11. The display device of claim 5, wherein
each of the first terminal and the second terminal has two slits, and
the first terminal has a contact hole between the two slits.

12. The display device of claim 1, wherein
the second substrate includes a fourth edge on the first edge side, a fifth edge overlapping the second edge, a sixth edge overlapping the third edge, a third round corner located between the fourth edge and the sixth edge, and a fourth round corner overlapping the second round corner.

13. The display device of claim 12, further comprising a display area which displays an image, wherein
the display area includes a fifth round corner on an inner periphery side of the third round corner.
